(19) United States
(12) Patent Application Publication
(10) Pub. No.: US 2010/0082437 A1
(43) Pub. Date: Apr. 1, 2010

(54) INFORMATION PROVIDING SERVER AND ITS MOBILE TERMINAL

(75) Inventors: Shotaro TAMAYAMA, Funabashi (JP); Nobuhiko MATSUKUMA, Tachikawa (JP); Takaaki ISHII, Kawasaki (JP); Kyoko OKOSHI, Sagamihara (JP)

Correspondence Address: MATTINGLY & MALUR, P.C., 1800 DIAGONAL ROAD, SUITE 370, ALEXANDRIA, VA, 22314, US

(73) Assignee: HITACHI AUTOMOTIVE SYSTEMS, LTD., Ibaraki (JP)

(21) Appl. No.: 12/542,988

(22) Filed: Aug. 18, 2009

(30) Foreign Application Priority Data
Sep. 29, 2008 (JP) 2008-249509
Jun. 23, 2009 (JP) 2009-148196

(51) Int. Cl. G06Q 30/00

(52) U.S. Cl. 705/14.58

(57) ABSTRACT

An advertisement information providing server and its terminals are provided in which landmarks along a route and high advertisement effects are supplied to users. Map information is displayed on the display apparatus of a mobile terminal, a route to a destination and picture information existing along the route are displayed on the map, and advertisement information compatible with the picture information is displayed. Access information of the mobile terminal is displayed together with the advertisement information, and adjusted in accordance with running of the mobile terminal.

### INCORPORATION BY REFERENCE

The present application claims priority from Japanese patent applications JP2008-249509 filed on Sep. 29, 2008 and JP2009-148196 filed on Jun. 23, 2009, the contents of which are hereby incorporated by reference into this application.

### BACKGROUND OF THE INVENTION

1. Field of the Invention

The present invention relates to an advertisement information providing server and its mobile terminals in which access information to an advertiser is provided by correcting it when necessary in accordance with a position of the mobile terminal.

2. Description of the Related Art

A navigation system is prevailing recently in which a position of a mobile terminal is recognized by a GPS function and displayed on a map. Particularly, a vehicle mount navigation system called a car navigator is essential for daily life of a user, and various proposals of improving ease to use have been made.

For example, according to conventional techniques, post picture information and advertisement information from a mobile terminal equipped with a camera is received, edited by an editor and provided to a user. It is also proposed to display advertisement information disposed on a map in an enlarged scale when the terminal reaches near to a predetermined distance. In a conventional car navigator, an estimated time to a destination is displayed, and a distance to a service area or intersection is displayed during running on a high speed way. These are disclosed in JP-A-2002-15078, JP-A-2005-31336 and JP-A-2001-91273.

### SUMMARY OF THE INVENTION

A conventional car navigator is convenient in that an arrival time at a destination and its route can be known. A photograph and an advertisement posted along the route are displayed, and when necessary in an enlarged scale so that necessary information can be acquired.

According to conventional techniques, a distance to an intermediate intersection and an intermediate service area along a high speed way or the like are displayed so that it is convenient to use the distance as a guide for lavatory and gasoline supply. However, an intermediate distance is not displayed on a general road having no landmark. Although post information such as a landscape photograph is a convenient landmark for road guide, a distance to the post information is not displayed. Although advertisement information is convenient for acquiring necessary information, it becomes an obstacle for route (map) confirmation during general running so that a user does not pay attention to the advertisement, resulting in an issue of low advertisement effects.

It is therefore an object of the present invention to provide an advertisement information providing server and its mobile terminals capable of supplying a user with a landmark along a route and providing high advertisement effects.

In order to achieve the above-described object of the present invention, information on a map is displayed on a display unit of a mobile terminal, a route to a destination and picture information existing along the route are displayed on the map, and advertisement information compatible with picture information is displayed. Access information of the mobile terminal is displayed together with the advertisement information, and adjusted in accordance with running of the mobile terminal.

More specifically, an advertisement information providing server for acquiring route information to a destination from a mobile terminal via a communication unit, acquiring picture information compatible with route information from a picture information management server for managing picture information having photographing coordinate information, and transmitting various information containing the acquired picture information to the mobile terminal, wherein: the advertisement information providing server comprises a map information management database storing map information and an advertisement information management database storing advertisement information containing location coordinate information and business time information; receives a departure time and the route information to the destination from the mobile terminal; acquires the picture information regarding the route information from the picture information management server; searches the advertisement information database by using as a search key the photographing coordinated information of the picture information, the location coordinate information and the business time information, to extract advertisement information effective when the mobile terminal arrives at a location corresponding to a location corresponding to the photographing coordinate information of the picture information; generates an advertisement window mapping the picture information and the advertisement information extracted in correspondence with the picture information along a route on a map; and transmits the advertisement window to the mobile terminal, the advertisement window having the picture information, a name of the extracted advertisement information, and access information to a location of the extracted advertisement information.

In this case, the picture information management server stores the picture information posted by a post member and having a search keyword, the advertisement information has type information to be used as the search keyword, and when the route information is to be received, the advertisement information providing server receives the search keyword, and generates the advertisement window having the picture information corresponding to the keyword and the advertisement information.

A mobile terminal of the present invention in an advertisement information providing system, has a position confirming unit, map information and a display unit, and connects an advertisement information providing server via the communication unit to acquire information on a route to a destination and advertisement information regarding the route, wherein: the mobile terminal displays a destination selection screen on the display unit, receives destination information and departure time information, transmits the destination information and departure time to the advertisement information providing server; acquires an advertisement window to be mapped along a route corresponding to the destination information, from the advertisement information providing server; maps the advertisement window on a map having the route corresponding to the information on the route; and displays the advertisement window and map on the display unit, the advertisement window having picture information with photographing coordinate information corresponding to the information on the route, coordinate information on a location near to a location corresponding to the photographing coordinate information, advertisement information effective when the mobile terminal arrives at a location corresponding to the photographing coordinate information, and access information to the coordinate information of the advertisement information.

In this case, the mobile terminal calculates again the access information in accordance with a predetermined running distance acquired by the position confirming unit to renew the access information when necessary. The mobile terminal displays, when the advertisement window is acquired from the advertisement information providing server 20, a whole route display screen on the display unit 46, the whole route display screen displaying the route to the destination to obtain user confirmation; receives the user confirmation of the route on the whole route display screen, and displays a present position guide screen on the display unit, the present position guide screen having the route having as a center a present position of the mobile terminal; the whole route display screen has a whole route display area for displaying a map mapping the advertisement window along the route and a window display area for displaying an enlarged window enlarging the advertisement window; the present position guide screen displays a map mapping the advertisement window along the route; and the advertisement window on the present position guide screen is displayed in an enlarged size at a position outside the route, when the mobile terminal arrives near at a location corresponding to a predetermined distance.

As above, according to the present invention, on a map displaying the route to a destination, picture information serving as a landmark of a route and advertisement information having access information are displayed as a combination. In this manner, advertisement information easy to be used by users can be provided.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating the structure of an advertisement information providing system according to an embodiment.

FIGS. 2A and 2B are diagrams illustrating the data structure of post information of a post car navigator terminal.

FIG. 3 is a diagram illustrating the data structure of a post information management DB (DataBase).

FIG. 4 is a diagram illustrating the data structure of an advertisement information management DB.

FIG. 5 is an operation flow diagram of a navigation system.

FIG. 6 is a screen transition diagram of a car navigator terminal.

FIG. 7 is a screen transition diagram of the car navigator terminal.

FIG. 8 is a screen transition diagram of the car navigator terminal.

FIG. 9 is a screen transition diagram of the car navigator terminal.

FIG. 10 is a diagram illustrating the structure of an advertisement information providing system according to a second embodiment.

FIG. 11 is a diagram illustrating an operation flow of an automatic photographing function of a post car navigator terminal of the second embodiment.

FIG. 12 is a diagram illustrating an operation flow of the post car navigator terminal of the second embodiment during photographing.

FIG. 13 is a diagram illustrating an operation flow of a car navigator terminal of the second embodiment.

### DESCRIPTION OF THE EMBODIMENTS

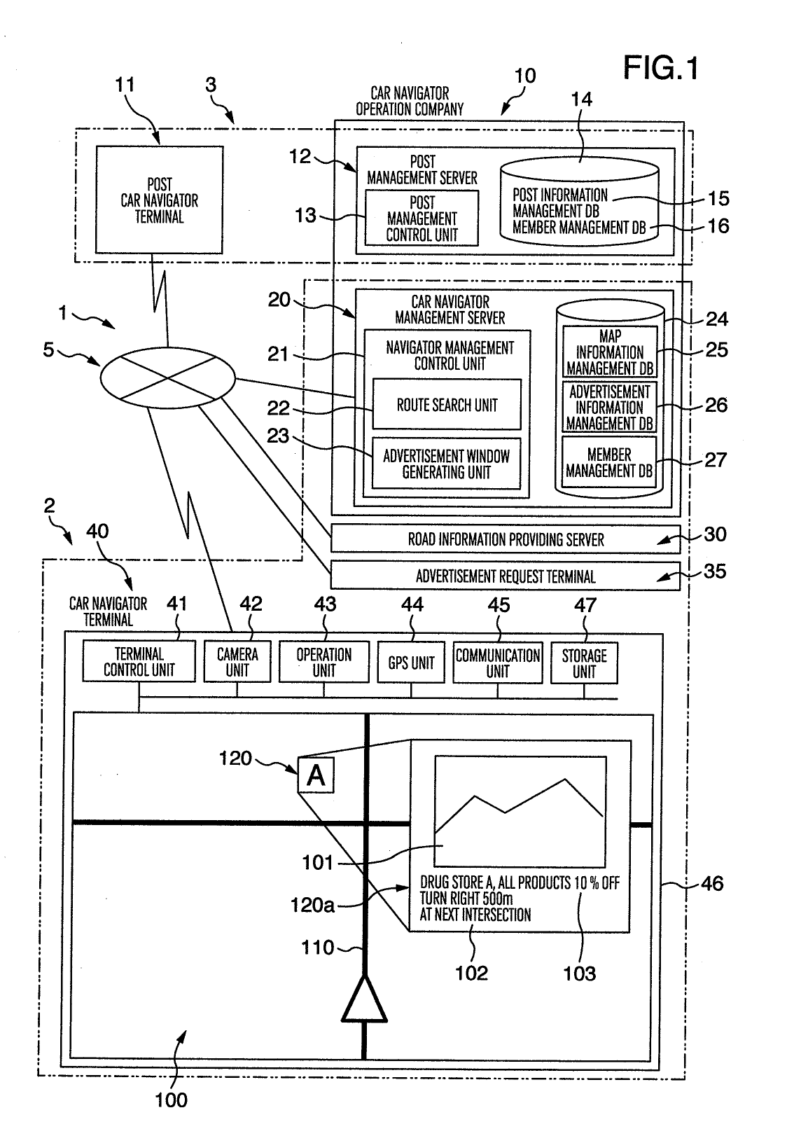

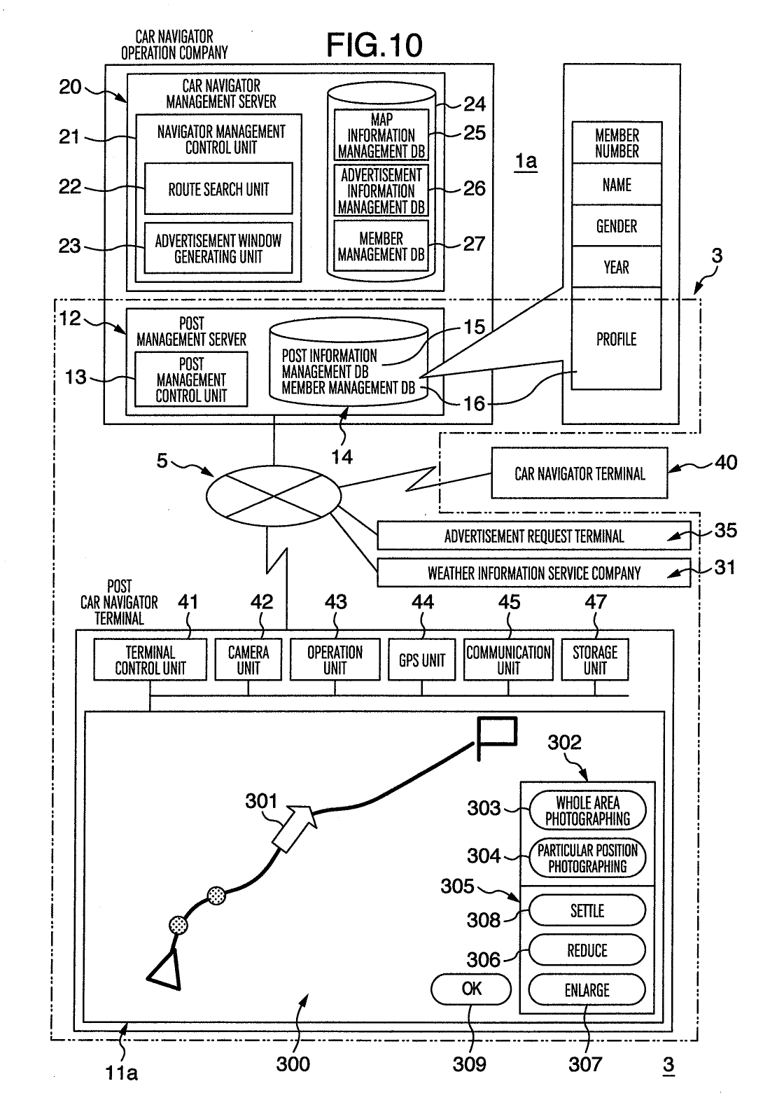

With reference to FIGS. 1 to 13, an advertisement information providing system of the present invention will be described specifically. FIGS. 1 to 9 illustrate an advertisement information providing system according to a first embodiment, and FIGS. 10 to 13 illustrate an advertisement information providing system according to a second embodiment. Same components, arrows and the like are represented by identical reference numerals, and the duplicated description is omitted.

### First Embodiment

FIGS. 1 to 9 illustrate the advertisement information providing system.

First, with reference to FIG. 1, the advertisement information providing system of the first embodiment will be described specifically. FIG. 1 is a diagram showing the structure of the advertisement information providing system of the embodiment.

In FIG. 1, the advertisement information providing system integrally indicated by reference numeral 1 includes a navigation system 2 for providing a user with various information such as an access route to a destination and advertisements and a post information collecting system 3 for collecting picture information to be supplied to users. The advertisement information providing system 1 provides a user with advertisement information 103 easy to be used by the user, by displaying an advertisement window 120 (enlarged window 120a) on a map 100 displaying a route 110 to a destination, displaying post information 101 collected from a user as picture information used as a landmark of the route 110, and displaying a combination of access information 102 and advertisement information 103 on the advertisement window 120 (enlarged window 120a).

The navigation system 2 includes a mobile terminal (hereinafter called a car navigator terminal) 40 installed in a car of a user; a car navigator management server (hereinafter called a car navigator management server) 20 for providing the car navigator terminal 40 with various information; a road information providing server 30 for providing the car navigator terminal 40 and car navigator management server 20 with road traffic information; an advertisement request terminal 35 for requesting the advertisement information 103 from the car navigator management server 20 and providing the advertisement information, and a communication network 5 for interconnecting above devices via wireless communication lines or wired communication lines.

The post information collecting system 3 includes a post car navigator terminal 11 for providing post information 101 as picture information and a post management server 12 for collecting and managing posted post information 101 via the communication network 5. The post car navigator terminal 11 of the embodiment is equipped with similar functions to those of the car navigator terminal 40, and the car navigator terminal 40 may become the post car navigator terminal 11.

Also in this embodiment, the car navigator management server 20 and post management server 12 may be run by a navigation operation company (hereinafter called a car navigator operation company), or by different operation companies.

The post management server 12 has a post management control unit 13 for integrally controlling the post management server 12, and a storage unit 14. The storage unit stores a post information management DB 15 for storing post information 101 and a member management DB 16 for storing a name list of members having the post car navigator terminal 11.

An object of the post information collecting system 3 of the embodiment is to make public and provide the post information 101 collected from each member to other members, to thereby share the post information 101 by all members. A member who supplied the post information is given a point corresponding to the post information, the post information 101 may be accumulated in the form of album, or additional information may be written into the post information.

The car navigator management server 20 has a navigator management control unit 21 for integrally controlling the car navigator management server 20, and a storage unit 24. The navigator management control unit 21 has a route search unit 22 for searching a route to a destination and an advertisement window generator unit 23 for generating the advertisement window 120 to be provided to the car navigator terminal 40. The storage unit 24 stores a map information management DB 25 for managing map information, an advertisement information management DB 26 for storing the advertisement information 103 collected from the advertisement request terminal 35, a member management DB 27 having a name list of members having the car navigator terminals 40, and other data. The car navigator operation company 10 may share in common the member management DB 16 of the post information collecting system 3 and the member management DB 27 of the navigation system 2.

The car navigator terminal 40 includes a terminal control unit 41 for integrally controlling the car navigator terminal 40; a camera 42, an operation unit 43 for operating the car navigator terminal 40; a GPS unit 44 using a global positioning system (GPS); a communication unit 45 for connecting the communication network 5; a display unit 46 for displaying various information; and a storage unit 47 for storing map information.

The road information providing server 30 is a well-known system for providing road traffic congestion information and road information such as construction. The advertisement request terminal 35 includes quite a general personal computer, and supplies the advertisement information 103 via the communication network 5.

One of main features of the advertisement information providing system 1 of the embodiment is to display the advertisement window 120 on the map 100 displaying the route 110 to a destination, and to display, on the advertisement window 120, the post information 101 collected from a user as picture information used as a landmark of the route 110.

Namely, a user utilizes this navigation system 2 as a guide to the destination. The user can arrive the destination by the shortest distance if the user follows correctly the route 110 provided by the navigation system 2. However, there is an issue in that a user may often miss the route 110 displayed on the map 100. This issue can be alleviated if a landmark such as a building and a landscape picture is displayed on the route 11.

General advertisement information is only supplementary information for a user using the navigation system. Information on eating facilities and convenience stores may be effective when this information is desired, but this information is not effective during ordinary car-driving not needing this information. In this context, it can be said that advertisement information by the navigation system has a small advertisement efficiency.

In this embodiment, therefore, the post information 101 provided by another user is utilized as the picture information to be displayed along the route 110. Since the post information 101 is information photographed (posted) by another user (post user) with interest, a user using this post information is likely to pay attention to the post information 101 with interest.

In this embodiment, the post information 101 and advertisement information 103 near the post information 101 is displayed in the advertisement window 120 as one set of information. Since the user visually recognizes at the same time the post information 101 and advertisement information 103 displayed in the advertisement window 120 as a landmark, it becomes easy for the user to acknowledge the advertisement information 103.

Another one of main features of the advertisement information providing system of this embodiment is that the advertisement information 103 displayed in the advertisement window 120 is accompanied by the access information 102.

Namely, according to conventional techniques, service areas, interchanges and the like along an express way are displayed together with distance information. This picture information is useful for a driver to know timings for rest or lavatory. However, since definite locations (landmarks) such as service areas and interchanges do not exist along a general road, distance information along the general road is not displayed.

In this embodiment, therefore, the access information 102 for accessing the post information 101 is displayed together with the post information 101 used as a landmark. The access information 102 constituted of the time, distance or the like relative to the post information 101 is useful information. In this embodiment, the access information 102 for accessing the advertiser existing near at the post information is displayed always as the latest information changed with running of the car navigator terminal 40. It is therefore possible to improve recognition of advertisement information of the advertiser provided with the access information 102. The access information 102 displayed is an estimated value so that it is used only for rough indication. Since it can be said that the access information 102 is information for accessing the post information 101, this information is useful landmark information for a user.

In this embodiment, as a car reaches a predetermined distance from the advertisement window 120, the enlarged window 120a is displayed in animation at a position separated from the route 110. The enlarged window 120a can be displayed also by selectively operating the advertisement window 120. In this embodiment, the advertisement window 120 displays the post information in the form of icon to the extent that an image of the post information 101 becomes distinguishable, and the enlarged window 120a displays an image of the post information 101, the name and outline information of the advertisement information 103, and the access information 102. By selectively operating the enlarged window 120a, it becomes possible to display a whole screen display (not shown) capable of displaying all information on the advertisement information.

Next, the advertisement information providing system 1 of the embodiment will be described in more detail.

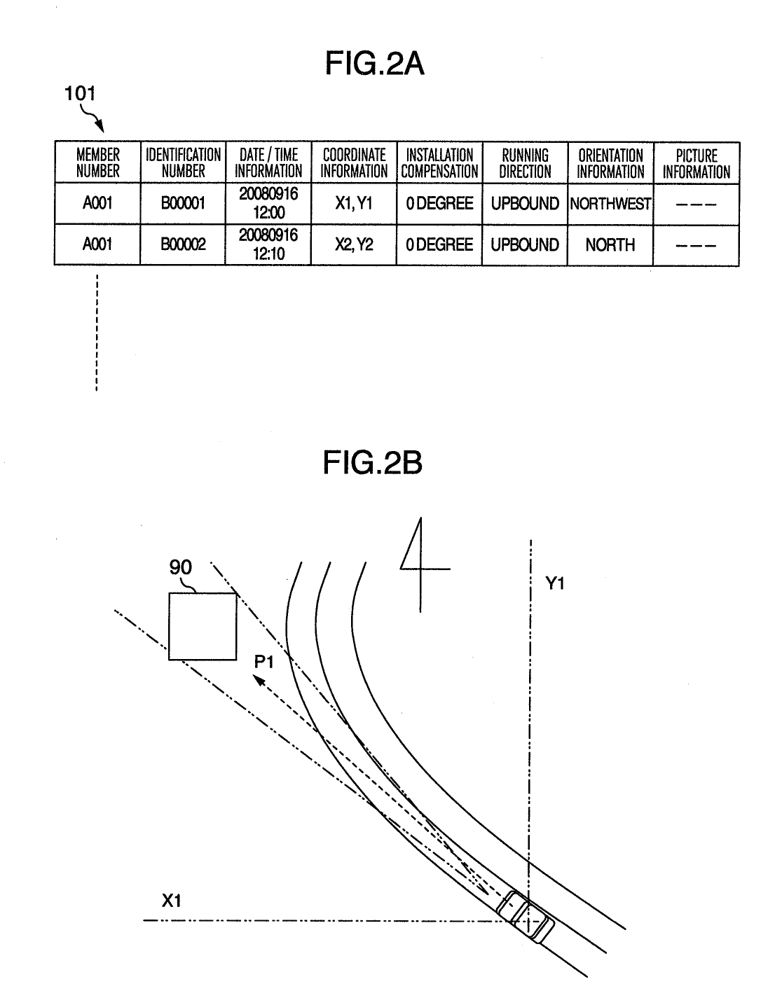

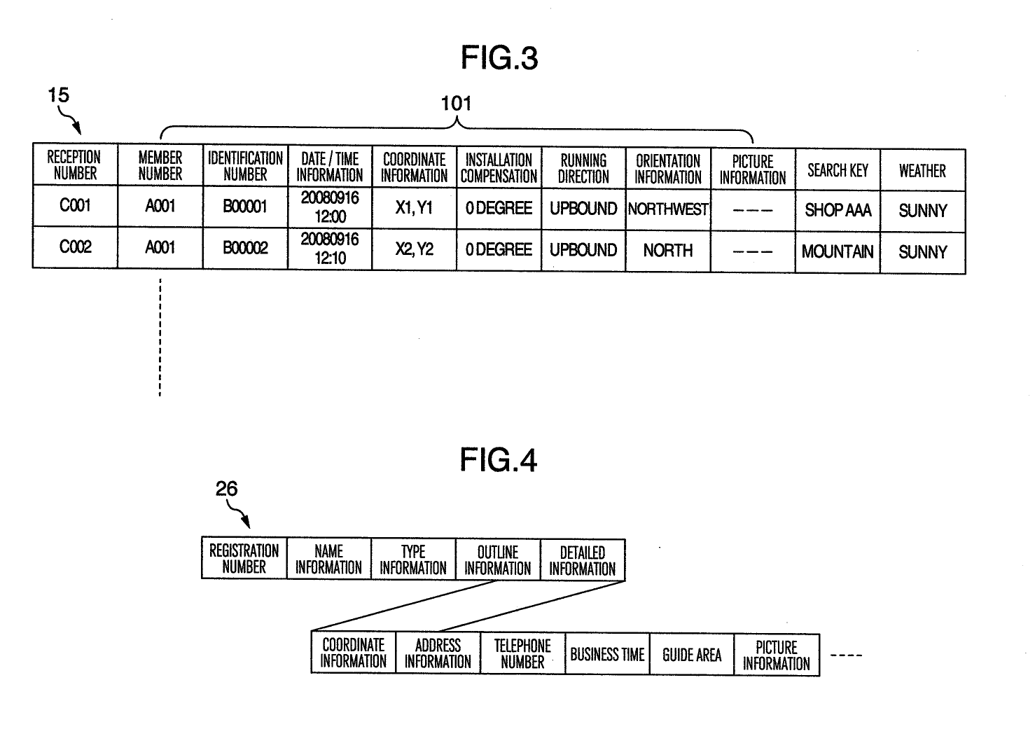

First, with reference to FIGS. 1, 2 and 3, the post information collecting system 3 will be described specifically. FIGS. 2A and 2B are diagrams illustrating the data structure of post information of a post car navigator terminal, FIG. 2A is a diagram illustrating the data structure of post information, and FIG. 2B is an illustrative diagram of a photographing state. FIG. 3 is a diagram illustrating the data structure of the post information management DB.

First, in this embodiment, similar to the car navigator terminal 40, the post car navigator terminal 11 illustrating in FIG. 1 has functions equivalent to those of a terminal control unit 415, a camera 42, an operation unit 43, a GPS unit 44, a communication unit 45, a display unit 46 and a storage unit 47. The car navigator terminal 40 and the post car navigator terminal 11 each become a vehicle mounted navigator terminal if it is mounted on a car dashboard, and become a portable navigator if it is held in hand by dismounting it from the dashboard.

As shown in FIG. 2B, if the post car navigator terminal 11 is mounted on a dashboard, a picture can be photographed by the camera while the car is run. For example, in the embodiment, an optical axis P1 of the camera 42 is set to a car running direction. With this mount, an object 90 along the running direction can be photographed in the state illustrated in FIG. 2B.

In the state illustrated in FIG. 2B, as a photographing switch of the operation unit 43 is operated, the terminal control unit (not shown) of the post car navigator terminal 11 generates the post information 101, and transmits it to the post management server 12. In this case, the terminal control unit may temporarily store the post information in a storage unit (not shown), and transmit accumulated post information to the post management server 12.

As illustrated in FIG. 2A, the post information 101 includes a member number identified for the post car navigator terminal 11; an unique identification number of a photographed picture automatically generated by the terminal control unit when the picture is photographed; information on photographed date/rime, information on coordinates on a photographed position; installation compensation for compensating for a shift of the camera 42 from a car running direction, a running direction representative of a road running direction; orientation information of the optical axis P1 (photographing direction) of the camera 42, and information on a photographed picture. The installation compensation is performed for compensating for an inclination of the optical axis P1 of the camera 42 from the car front direction. The running direction indicates “upbound” and downbound” directions of the road on which a car is run, and is acquired from map information.

In FIG. 3, when the post management server 12 of the embodiment receives the post information 101, the post information is stored in the post information management DB 15. The post information management DB 15 stores a reception number given in the order of receiving the post information 101, the member number, and each corresponding item of the posted post information 101. In addition to these, the embodiment provides input fields for a search key and weather.

In this embodiment, a post member or user can access later the post management server 12 via a personal computer (not shown), and can input information on the search key and weather as supplementary information of the object 90. The post member can search and extract own post information stored in the post information management DB 15 via the date and a search key so that the post member can use the extracted data as its own album. The post member can also make public the post information 101 and can provide it to other users. In this case, a storage fee for the post information 101 may be reduced or a point may be given.

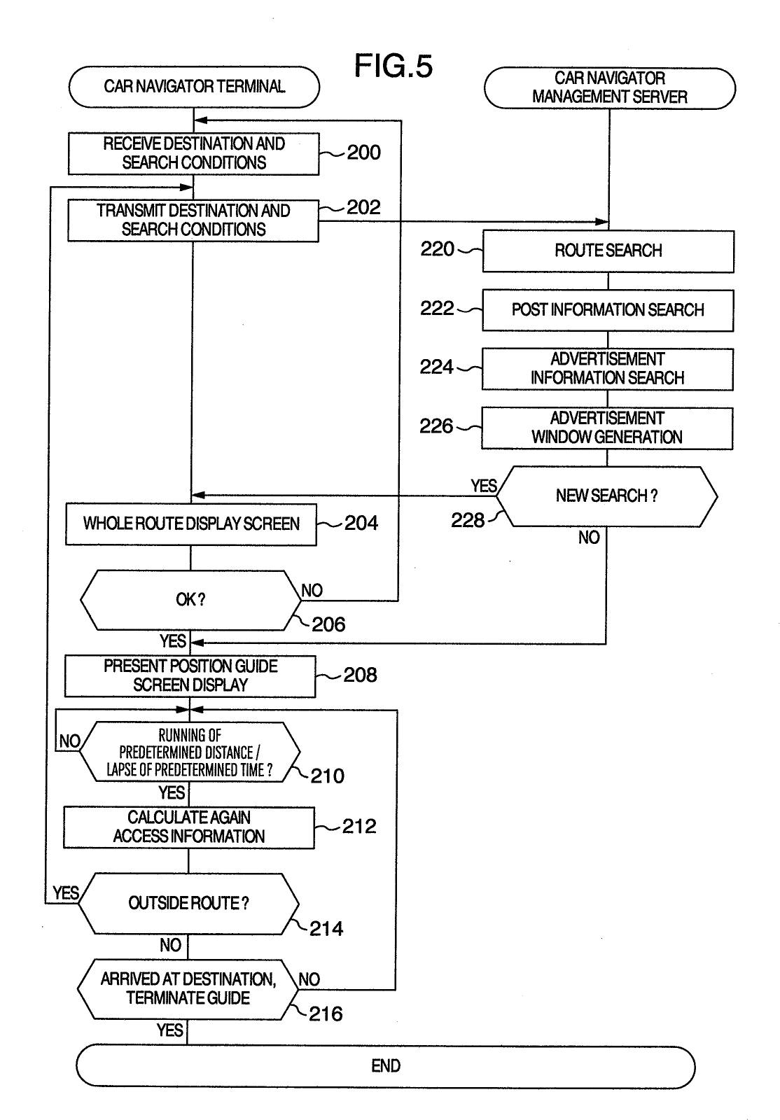

Next, with reference to FIGS. 1 and 4, the advertisement information management DB 26 will be described specifically. FIG. 4 is a diagram illustrating the data structure of the advertisement information management DB.

First, in this embodiment, upon reception of a request for an advertisement from the advertisement request terminal 35, the car navigator management server 20 illustrated in FIG. 1 stores the request information in the advertisement information management DB 26. The data structure of the advertisement information management DB 29 is illustrated in FIG. 4.

In FIG. 4, the advertisement information management DB 26 includes a registration number uniquely assigned in the request order; name information of an advertiser name such as a shop name; type information selected from predetermined selection candidates including a gas station, a restaurant, a convenience store and the like; outline information representative of an advertisement outline; detailed information representative of detailed advertisement information; coordinate information for identifying a location of the advertiser; address information of the advertiser; a telephone number of the advertiser; a business hour of the advertiser; and a guide area representative of a service area of advertisement information.

The advertiser corresponds to a shop at a location identified by the coordinate information, and if an advertisement company has a plurality of service branch offices, each branch office is registered as the advertiser. The guide area indicates an area capable of providing the advertisement information 103 if the post information 101 is photographed in this area. For example, if the guide area has a diameter of 5 km and there is a position photographed in the guide area of 5 km, it is possible to extract the advertisement information 103 of the photographed post information 101.

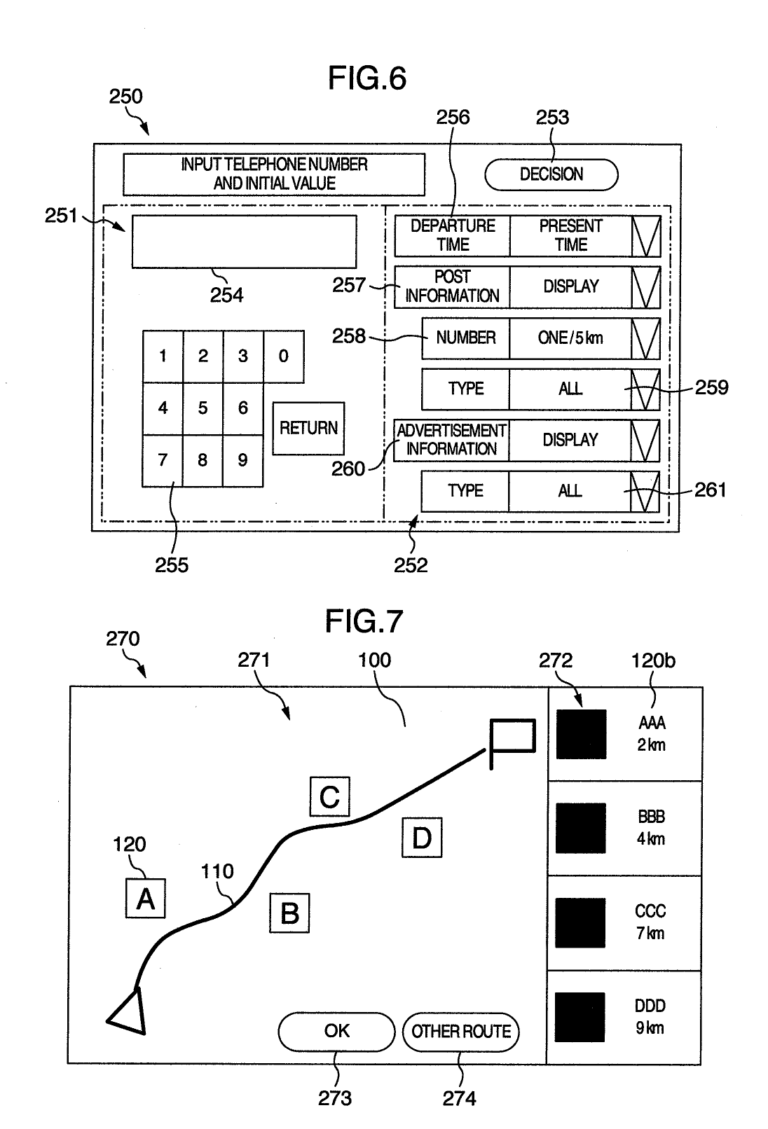

Next, description will be made on the operation flow of the navigation system 2 of the embodiment along with the operation flow illustrated in FIG. 5, with reference to the diagram of the system structure illustrated in FIG. 1 and screen transition diagrams illustrated in FIGS. 6 to 9. FIG. 5 is an operation flow diagram for the navigation system. FIGS. 6 to 9 are screen transition diagrams of the car navigator terminal.

In FIG. 5, as a user selects a destination selection from a menu screen (not shown), the terminal control unit 41 of the car navigator terminal 40 displays a destination selection screen 250 illustrated in FIG. 6. In this embodiment, a destination can be selected from “name”, “address” and “telephone number”. FIG. 6 illustrates a selection screen 250 for a “telephone number”. A selection screen for selecting a “telephone number” is omitted.

In FIG. 6, the destination selection screen 250 has a destination selection area 251 for inputting a telephone number, a search condition setting area 252 for setting search conditions, and a decision button 253. In this embodiment, a touch panel constituting a portion of the operation unit 43 is provided in front of the display unit 46 to allow an input operation by touching the screen.

The destination selection area 251 includes an input confirmation display unit 254 and a character input unit 255. Since the destination selection screen 250 is used for setting a telephone number, the character input unit 255 is a ten-key. If “name” or “address” is to be used, the character input unit 255 is a character input key group.

The search condition setting area 252 includes a departure time setting unit 256, a post information setting unit 257, a number setting unit 258 and a type selecting unit 259 for the post information 101, an advertisement information setting unit 260 and a type selecting unit 261 for the advertisement information 103. In this embodiment, settings of the search condition setting area 252 can be input by touching a pulldown button to display selection candidates, and touching one of the candidates.

The departure time setting unit 256 has a present time as an initial value, and if a different time is to be set, this time can be selected from a pulldown. The post information setting unit 257 is used to select whether the post information is displayed or not. In FIG. 6, “display” is used as an initial value. If the post information setting unit 257 is set to “no display”, the number setting unit 258, the type selecting unit 259, the advertisement information setting unit 260 and the type selecting unit 261 become an inactive display state, and these settings cannot be entered. The number setting unit 258 is used for limiting the number of pieces of post information 101 to be displayed and, in this embodiment, a distance for displaying one post information is set. The type selecting unit 259 is used for setting types corresponding to the search keys of the post information 101 illustrated in FIG. 3. In this embodiment, “all” is set as an initial value.

The advertisement information setting unit 260 is used for setting whether the advertisement information 103 is displayed or not, and “display” is set as an initial value. If “no display” is selected for the advertisement information setting unit 260, the type selecting unit 261 becomes an inactive state, and the setting cannot be entered. The type selecting unit 261 is used for selecting the type information illustrated in FIG. 4. As a pulldown button is operated, selection candidates such as “gas station” and “restaurant” are displayed and one of them can be selected. In this example, “all” is set as an initial value.

In this embodiment, although the principle is to display a combination of the post information 101 and advertisement information 103, the advertisement information 103 can be displayed even if the post information setting unit 257 is “no display”. This setting can be entered from a setting screen (not shown). In this case, the post information 101 is not displayed, and instead, picture information of the advertisement information 103 is displayed.

Reverting to FIG. 5, as a predetermined destination is input and the decision button 253 is touched on the destination selection screen 250, the terminal control unit 41 receives this information (Step 200), and transmits the destination, search conditions and information that this request is a new search, to the car navigator management server 20 (Step 202).

The navigator management control unit 21 of the car navigator management server 20 makes the route search unit 22 illustrated in FIG. 1 operate to execute route search to the destination (Step 220). The route search unit 22 searches an optimum route 110 to the destination by referring to the map information management DB 25. As the search for the route 110 is completed, the navigator management control unit 21 executes search for the post information 101 (Step 222). In this embodiment, the post management server 12 searches the post information 101. Therefore, the navigator management control unit 21 asks the post management control unit 13 of the post management server 12 to select the post information 101 suitable for the route 101.

The asked post management control unit 13 divides the route 110 searched based on the set value in the number setting unit 258, extracts the post information 101 optimum to the first division area by referring to the coordinate information of the division area and the set value of the type selecting unit 258, repeats this operation sequentially in the following division areas to extract the post information 101 up to the destination and returns the post information to the navigator management control unit 21.

This search for the post information 101 is only illustrative, and not limitative. For example, a ranking item may be provided in the post information management DB 15 to extract the post information in accordance with a rank, or the post information may be extracted randomly. Further, the type information may be enriched to improve a selection precision.

If there are a plurality of pieces of post information in one division area, the latest picture can be provided if the post information of the latest date/time is extracted. Further, by extracting the post information having the time near at the request time, it becomes possible to provide picture information such as environmental brightness and shade direction simulating the state of the requesting car navigator terminal. Further, if information such as a running speed and a camera height during photographing the post information is stored as the post information, it becomes possible to provide picture information matching the running speed, mount height, and running direction of the requesting car navigator terminal. It is also possible to extract picture information corresponding to weather and season.

As the post information 101 is extracted, the navigator control unit 21 searches the advertisement information 103 compatible with the post information (Step 224). In this search, an access time to the extracted post information 101 is calculated from the time information set in the departure time setting unit 256, and the advertisement information nearest to the access time compatible with the business time is extracted.

Next, as the advertisement information 103 is extracted, the navigator management control unit 21 makes the advertisement window generating unit 23 illustrated in FIG. 1 operate to generate the advertisement window 120 having the coordinate information (Step 226). After this generation is completed, the navigator management control unit 21 judges whether this route search request is new search or not (Step 228). If new search, the generated advertisement window 120 and data regarding the advertisement window 120 are transmitted to the car navigator terminal 40.

On the other hand, the terminal control unit 41 of the car navigator terminal 40 which received the advertisement window 120 extracts a map corresponding to the route 110 from the map information stored in the storage unit 47, and synthesizes an extracted map 100 and the advertisement window 120 having the coordinate information to display first a whole route display screen 270 illustrated in FIG. 7 (Step 204).

The whole route display screen 270 illustrated in FIG. 7 has a whole route display area 271, a window display area 272 for the enlarged window 120a, an OK button 273, and another route selection button 274. The route 110 on the map 100 is displayed in the whole route display area 271, and advertisement windows 120 in an icon style are disposed along the route 110. The enlarged windows 120b corresponding to the advertisement windows 120 are disposed in the window display area 272 up and down in a list style. If all the enlarged windows 120b cannot be displayed in the window display area 272, a scroll bar (not shown) is provided.

In this whole route display screen 270, since the enlarged window 120b has the access information 102, the access state of the post information 101 along the whole route can be confirmed by comparing the advertisement window 120 disposed along the route 110 with the enlarged window 120b corresponding to the advertisement window 120.

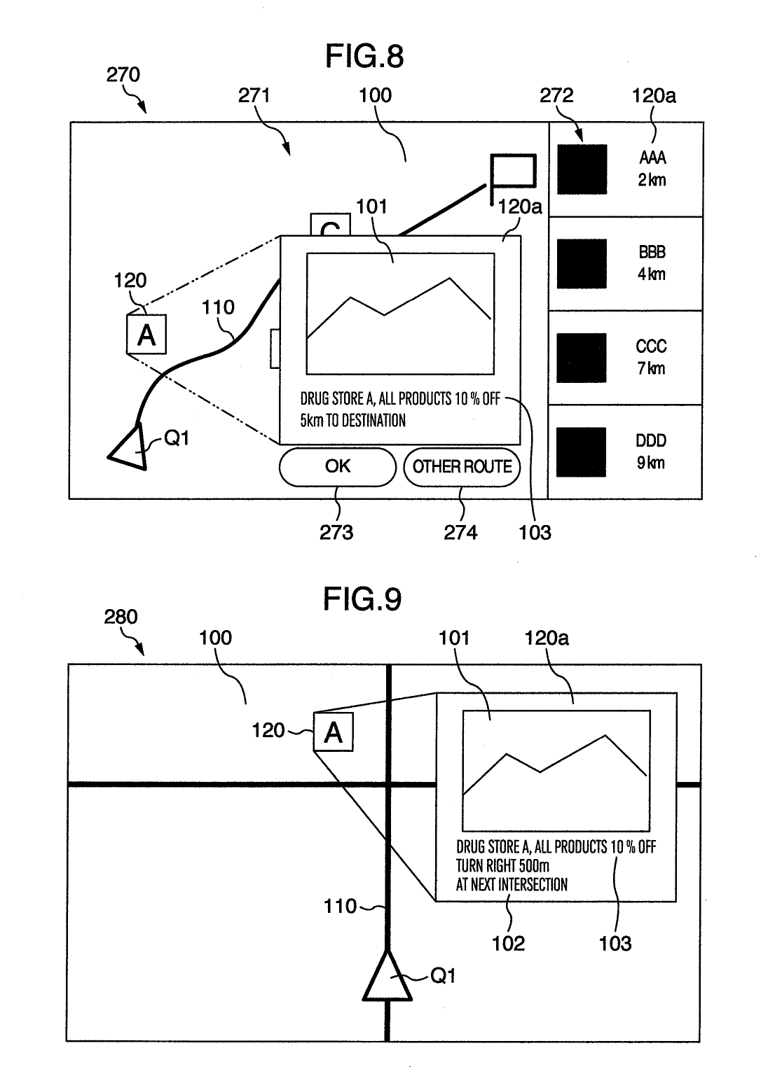

As the advertisement window 120 in the state illustrates in FIG. 7 is touched, the enlarged window 120a as illustrated in FIG. 8 is displayed through animation. Information detailed and enlarged more than the enlarged window 120b displayed in the list style is displayed in this enlarged window 120a. This information contains: picture information of the post information 101; a name of the advertisement information 103, e.g., “drug store A”; outline information, e.g., “all products 10% OFF”; and access information 102, e.g., “5 Km to destination”. This information displays the detailed content of the post information 101, and a remaining distance to the post information 101. Therefore, it is possible to know a rough distance to the post information 101 selected in the whole route 110, and it is convenient because this distance becomes as a landmark of the route.

Reverting to FIG. 5, as the OK button 273 is selected on the whole route display screen 270, the terminal control unit 41 displays a present position guide screen 280 illustrated in FIG. 9 (Step 208), whereas if the other route button 274 is selected, the flow returns to Step 200 whereas the destination selection screen 250 illustrated in FIG. 6 is again displayed (Step 206).

Next, in the embodiment illustrated in FIG. 9, as the route 110 is established, the present position guide screen 280 is displayed drawing the route 110 on the map 100 by using the present position Q1 as a center. In this embodiment, the advertisement window 120 displaying the post information 101 is displayed along the route 110 in an icon style. When the car comes near the advertisement window 120 at a predetermined distance, the enlarged window 120a is displayed through animation at the position spaced from the route 110. This enlarged window 120a displays picture information of the post information 101, a name of the advertisement information 103, e.g., “drug store A”, outline information, e.g., “all products 10% OFF, and access information 102, e.g., “turn right 500 m at next intersection”. As described above, in this embodiment, the access information 102 guides on a distance to a place (shop) of the advertisement information 103 of an advertiser when the car comes near the post information 101.

Reverting to FIG. 5, after the route guide starts, the terminal control unit 41 monitors whether the car has run a predetermined distance or a predetermined time period has lapsed (Step 210). If this condition is met, a distance (including a time period required) to the coordinate information (refer to FIG. 4) of the advertisement information 103 up to the destination is sequentially calculated to update the access information 102 accompanied by the advertisement window 120 and update the distance to and the time required for the destination (Step 212).

The terminal control unit 41 also monitors whether the car is outside the preset route (Step 214). If the terminal control unit 41 judges that the car is outside the route, a re-search signal is added to return to Step 202 and repeat again Steps 220 to 226. Since it is judged at Step 228 that the search is not new, the flow advances to Step 208 by skipping Steps 204 and 206.

If the car is not outside the route, it is monitored whether the car arrives at the destination (Step 216). If the car does not arrive, the flow returns to Step 210, whereas if the car arrives at the destination, the route guide process is terminated.

As above, according to the embodiment, a guide to an advertiser shop (a road traffic state, a route and an arrival time calculated from the mobile terminal position) can be automatically generated, and an advertisement can be distributed matching a shop open time. In this embodiment, therefore, a route to the shop and an arrival time can be known without route search by a user. Route search is performed matching the state, and a time taken to arrival can be known precisely. Since the advertisement is performed matching a shop open time, a user can arrive at it during a business time.

In the description of the car navigator terminal 40 of the embodiment, the advertisement window 120 and relevant information supplied from the car navigator management server 20 are synthesized with the map information. The embodiment is not limited thereto, but the operation may be shared by the car navigator terminal 40 and car navigator management server 20. Namely, it is sufficient if the car navigator management server 20 extracts the post information 101 along the route 110, and the advertisement information 103 corresponding to the post information. Therefore, search for the route 110, synthesis of the map 100, post information 101 and advertisement information 103, calculation of access information 102 and the like may be shared by both the car navigator terminal 40 and car navigator management server 20 or performed by one of them.

In the above description, although the access information is represented by a distance, it may be represented by an arrival time.

In the advertisement information providing system 1 of the embodiment, map information is displayed on the display unit 46 of a mobile terminal (car navigator terminal 40), the route 110 to a destination and picture information 101 existing along the route 110 are displayed on the map 101, and advertisement information 103 compatible with the picture information 101 is displayed. Access information 102 of the mobile terminal 40 is displayed together with the advertisement information 103, and adjusted in accordance with running of the mobile terminal.

Namely, the advertisement information providing server (car navigator management server 20) for acquiring route information to a destination from a mobile terminal 40 via a communication unit, acquiring picture information 101 compatible with the route information from a picture information management server (post management server 12) for managing picture information (post information 101) having photographing coordinate information, and transmitting various information containing the acquired picture information 101 to the mobile terminal 40, wherein: the advertisement information providing server comprises a map information management database 25 storing map information and an advertisement information management database 26 storing advertisement information containing location coordinate information and business time information; receives a departure time and the route information to the destination from the mobile terminal 40; acquires the picture information 101 regarding the route information from the picture information management server 12; searches the advertisement information database 26 by using as a search key the photographing coordinated information of the picture information, the location coordinate information and the business time information, to extract advertisement information 103 effective when the mobile terminal 40 arrives at a location corresponding to a location corresponding to the photographing coordinate information of the picture information 101; generates an advertisement window 120 (enlarged window 120a) mapping the picture information 101 and the advertisement information 103 extracted in correspondence with the picture information 101 along a route on a map 100; and transmits the advertisement window 120 to the mobile terminal 40, the advertisement window having the picture information 101, a name of the extracted advertisement information 103, and access information 102 to a location of the extracted advertisement information.

In this case, the picture information management server 12 stores the picture information 101 posted by a post member and having a search keyword, the advertisement information 103 has type information to be used as the search keyword, and when the route information is to be received, the advertisement information providing server 20 receives the search keyword, and generates the advertisement window 120 having the picture information 101 corresponding to the keyword and the advertisement information 103.

A mobile terminal 40 of the present invention in an advertisement information providing system (navigation system 2), has a position confirming unit 44, map information and a display unit 46, and connects an advertisement information providing server 20 via a communication unit 45 to acquire information on a route to a destination and advertisement information 103 regarding the route 110, wherein: the mobile terminal displays a destination selection screen 250 on the display unit 46, receives destination information and departure time information, transmits the destination information and departure time to the advertisement information providing server 20; acquires an advertisement window 120 (enlarged window 120a) to be mapped along a route 110 corresponding to the destination information, from the advertisement information providing server 20; maps the advertisement window 120 on a map 100 having the route corresponding to the information on the route; and displays the advertisement window and map on the display unit 46, the advertisement window 120 having picture information 101 with photographing coordinate information corresponding to the information on the route, coordinate information on a location near to a location corresponding to the photographing coordinate information, advertisement information 103 effective when the mobile terminal 40 arrives at a location corresponding to the photographing coordinate information, and access information 102 to the coordinate information of the advertisement information 103.

In this case, the mobile terminal 40 calculates again the access information 102 in accordance with a predetermined running distance acquired by the position confirming unit 44 to renew the access information when necessary. The mobile terminal 40 displays, when the advertisement window 120 is acquired from the advertisement information providing server 20, a whole route display screen 270 on the display unit 46, the whole route display screen displaying the route 110 to the destination to obtain user confirmation; receives the user confirmation of the route on the whole route display screen 270, and displays a present position guide screen 280 on the display unit, the present position guide screen having the route 110 having as a center a present position of the mobile terminal 40; the whole route display screen 270 has a whole route display area 271 for displaying a map 100 mapping the advertisement window 120 along the route and a window display area 272 for displaying an enlarged window enlarging the advertisement window 120; the present position guide screen 280 displays a map 100 mapping the advertisement window 120 along the route 110; and the advertisement window 120 on the present position guide screen 280 is displayed in an enlarged size at a position outside the route, when the mobile terminal arrives near at a location corresponding to a predetermined distance.

As above, according to the embodiment, on a map displaying the route to a destination, picture information serving as a landmark of a route and advertisement information having access information are displayed as a combination. In this manner, advertisement information easy to be used by users can be provided.

### Second Embodiment

FIG. 10 illustrates an advertisement information providing system 1a. One of features of the advertisement information providing system 1a is to configure a post information collecting system capable of easily performing photographing and editing picture information to be posted, and managing photographing and editing together with a member management DB 16 with enriched information on year, gender, hobby and the like of each post member. The advertisement information providing system 1a has the same fundamental structure as that of the first embodiment. In the following, different points will be described as main targets.

First, referring to FIG. 10, description will be made on a post car navigator terminal 11a capable of easily performing photographing and editing of picture information to be posted. The post car navigator terminal 11a has a large capacity storage unit 47. A whole route 110 or a part of the whole route 110 initially set is photographed as moving images, and a still image to be posted is clipped from the photographed moving images, as post images 101.

A photographing position setting screen 300 is displayed on a display unit 46 of the post car navigator terminal 11a illustrated in FIG. 10. This photographing position setting screen 300 is displayed at Step 206 and following Steps illustrated in FIG. 5, and can be called by operating an operation unit 43 of the post car navigator terminal 11a. The whole route 110 is displayed on the photographing position setting screen 300, and a photographing icon 301 indicating a photographing point is displayed on the whole route 110.

A photographing area designating button group 302 and a photographing position designating button group 305 are disposed on the photographing position setting screen 300. The photographing area designating button group 302 includes a whole area photographing button 303 and a particular position photographing button 304. As the whole area photographing button 303 is selected, the whole route 110 is photographed. In this case, the photographing position designating button group 305 is deactivated. On the other hand, as the particular position photographing button 304 is selected, the photographing position designating button group 305 is activated. In this case, the photographing position of the whole route 110 can be set by operating the photographing position designating button group 305.

For example, the state of FIG. 10 illustrates that two particular positions are set and a third particular position is intended to be set. In this embodiment, as a particular position is set, photographing starts at a predetermined distance using as a center a particular position, or at a time before a predetermined time, and ends at a predetermined distance after the post car navigator terminal passes the particular position, or at a time after a predetermined time. When a picture at a photographing position is to be changed, an editing function (not shown) can change a picture because pictures before and after the photographing position are recorded.

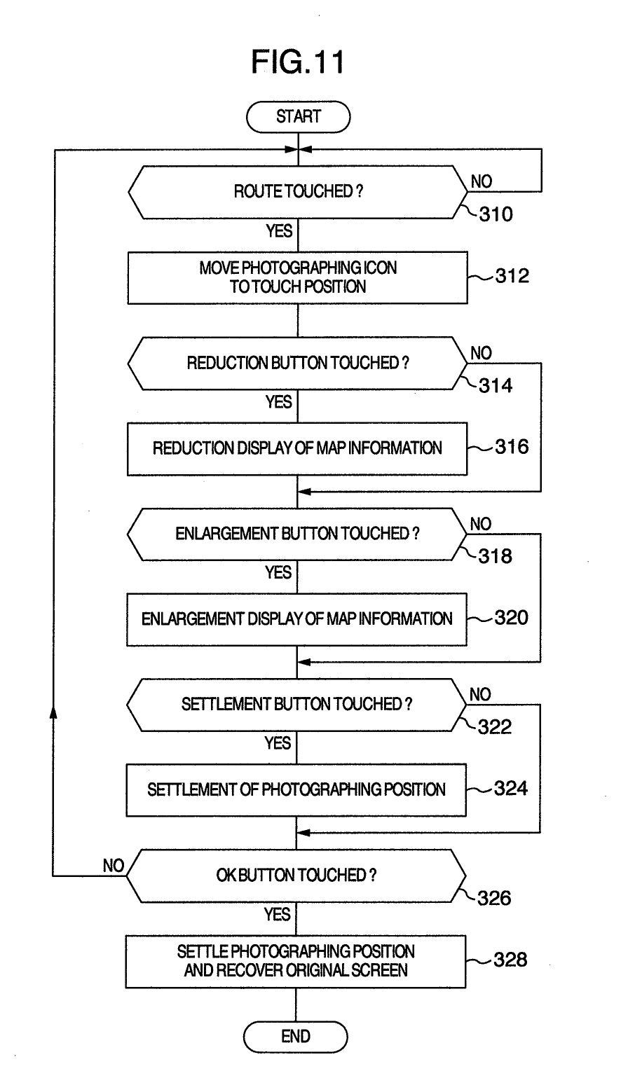

FIG. 11 illustrates an operation flow of an automatic photographing function. Referring to FIGS. 10 and 11, a terminal control unit 41 of the post car navigator terminal 11a monitors whether the route 110 displayed on the display unit 46 is touched or not (Step 310). As the route 110 is touched, the terminal control unit 41 moves the photographing icon 301 to the touched position (Step 312). Whereat the terminal control unit monitors a reduction button 306 (Step 314), an enlargement button 307 (Step 318), a settlement button 308 (Step 322) and an OK button 309 (Step 326).

First, as the reduction button 306 is selected, the map information reduced by using the photographing icon 301 as a center is displayed (Step 316). As the enlargement button 307 is touched, the map information enlarged by using the photographing icon 301 as a center is displayed (Step 320). As the settlement button 308 is touched, the photographing position is settled (Step 324). If the OK button 309 is not touched, the flow returns to Step 310, whereas if the OK button 309 is touched, the photographing position is settled to recover the original screen (Step 328) and terminate the process.

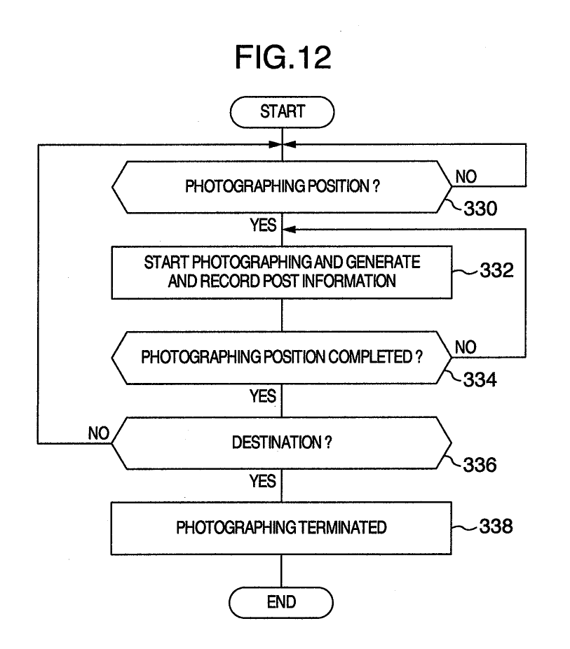

FIG. 12 illustrates an operation flow of the terminal control unit 41 of the embodiment during photographing. With reference to FIGS. 10 and 12, if the destination is set and the route 110 and the photographing position of the route are set, the terminal control unit 41 executes the operation flow illustrated in FIG. 12.

Namely, the terminal control unit 41 monitors whether the present position is the photographing position (Step 330). If the terminal control unit 41 judges that the present position is the photographing position, a picture acquired by a camera unit 42 is recorded in a storage unit 47, and post information 101 is generated and stored in the storage unit 47 in connection with the acquired picture being recorded (Step 332). In this embodiment, as photographing starts, photographed pictures together with the post information 101 shown in FIG. 3 are recorded in correspondence with moving images. In this manner, the post information 101 is settled in correspondence with the particular position (clipping) of moving images. Even if the picture at the photographing position is changed, the post information 101 corresponding to the picture can be acquired.

The terminal control unit 41 monitors whether the photographing position is completed (Step 334), and if the photographing position is not completed, the flow returns to Step 332, whereas if completed, it is judged whether the present position is a destination (Step 336). If not the destination, the flow returns to Step 330, whereas if the destination, photographing is terminated (Step 338).

The camera unit 42 of the embodiment is always in an active state, and stores pictures in the storage unit 47 at a photographing position. Instead, the camera unit 42 may be turned on at each photographing position to store pictures.

As illustrated in FIG. 10, the post car navigator terminal 11a of the embodiment can connect a weather information service company 31 via a communication network 5, acquire weather information at the position of the post car navigator terminal 11a from the weather information service company 31, and store the weather information in the storage unit 47 each time photographing is performed, as one item of the post information 101. Instead of the weather information, other information such as local information at the position of the car navigator terminal 11a may be acquired and stored in the storage unit.

The post management server 12 of the embodiment stores profile information of each member in a member management DB stored in the storage unit 14. Namely, as illustrated in FIG. 10, the post information collecting system of the embodiment acquires profile information such as hobby and taste in addition to the name, gender and age of a member, at the time of member subscription, and stores the acquired profile information in the member management DB 16. It is therefore possible to set the profile information as a search condition when the post information is to be searched.

In this embodiment, therefore, at Step 222 of the post information search illustrated in FIG. 5, the post information 101 matching a user of the car navigator terminal 40 can be provided in accordance with the profile information.

In this embodiment, for example, a profile information input column (not shown) is prepared for the destination selection screen 250 illustrated in FIG. 6 to receive the profile information as one of the search conditions. Upon reception of a search request for post information, the post management control unit 13 divides the route searched based on a value set to the number setting unit 258, and by referring to coordinate information of the first division area of the route 110 and a value set to the type selecting unit 259, extracts the post information 101 optimum to the division area. In this case, as the optimum post information 101, the post information 101 of the post member having coincident profile information is extracted. This operation is sequentially repeated in the following division areas to extract the post information 101 up to the destination and returns the post information to the navigator management control unit 21. In this manner, a selection precision can be improved.

Also in this embodiment, this profile information can be utilized for selecting the advertisement information. Namely, in this embodiment, the profile information of a customer requested by an advertiser is received when the advertisement information is requested, and stored in the advertisement information management DB 26 as the profile information (not shown). In this manner, the advertiser can select users to which the advertisement information is provided.

In this embodiment, for example, at Step 224 in FIG. 5 the navigator management control unit 21 calculates an arrival time at the extracted post information 101 from the time information set to the departure time setting unit 256, and extracts the advertisement information nearest to the arrival time coincident with the business time. In this case, the profile information stored in the advertisement information management DB 26 is used as one of the search conditions. Since users (customers) can be selected by the advertiser, an advertisement efficiency can be improved.

Advertisement display area information set by the advertiser when the advertisement information request is issued may be stored in the advertisement information management DB to be used as one of the search conditions. If the advertisement display area is set broadly, the advertisement information can be extracted in some cases even if the post information is far away.

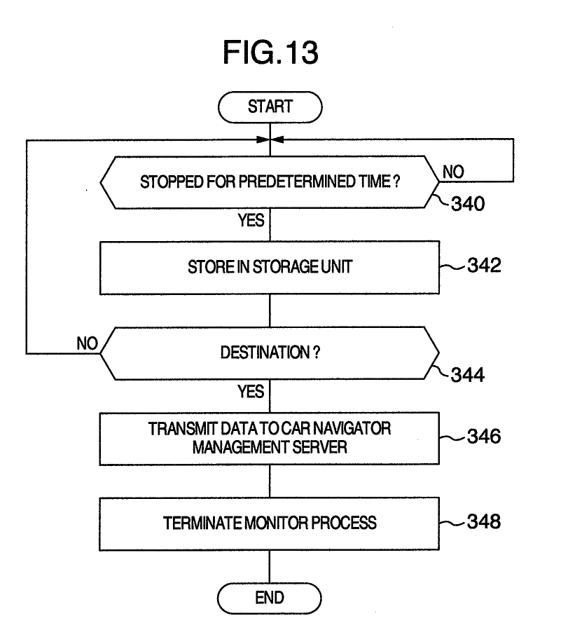

Also in this embodiment, as services for the advertiser, position information of the car navigator terminal 40 is monitored so that it is possible to provide stop information at the position coincident with the address information of an advertiser stored in the advertisement information management DB. This operation will be described further with reference to the operation flow of a car navigator terminal illustrated in FIG. 13.

In FIG. 13, as the car navigator terminal 40 starts running to the set destination, it is monitored whether the car navigator terminal 40 stops for a predetermined time (Step 340). If the car navigator terminal 40 stops for the predetermined time, a stop position and date/time information are stored in the storage unit 47 (Step 342), and it is judged whether the stop position is the destination (Step 344). If the stop position is not the destination, the flow returns to Step 340, whereas if the stop position is the destination, data of the stop position stored in the storage unit 47 is transmitted to the car navigator management server 20 (Step 346) to thereafter terminate the monitor process (Step 348).

Upon reception of the data of the stop position, the car navigator management server 20 searches the advertisement information management DB and judges whether the stop position is coincident with the address information in the advertisement information management DB 26 in FIG. 4. If there is the coincident address information, the date/time information and member number are stored in a customer DB (not shown) in the storage unit 14.

According to the embodiment, information in the customer DB can be provided to the advertisement request terminal 35 upon request from the advertisement request terminal 35 or periodically. An advertiser can recognize the advertisement effects as numerical values.

The car navigation terminal 40 of the embodiment does not extract post information and advertisement information of a general road if the route 110 is a high speed way and the post information 101 and advertisement information is along the general route.

In this embodiment, since weather information can be acquired automatically, post information 101 having weather information compatible with the weather during running can be selected at Step 222 in FIG. 5. Similarly, since season, a day of the week and the like can be used as the search conditions for the post information 101, the post information 101 matching the conditions during running can be acquired.

It should be further understood by those skilled in the art that although the foregoing description has been made on embodiments of the invention, the invention is not limited thereto and various changes and modifications may be made without departing from the spirit of the invention and the scope of the appended claims.

1. An advertisement information providing server for acquiring route information to a destination from a mobile terminal via a communication unit, acquiring picture information compatible with said route information from a picture information management server for managing picture information having photographing coordinate information, and transmitting various information containing said acquired picture information to said mobile terminal, said advertisement information providing server comprises:
a map information management database storing map information and;
an advertisement information management database storing advertisement information containing location coordinate information and business time information,
wherein the advertisement information providing server receives a departure time and said route information to the destination from said mobile terminal;
acquires said picture information regarding said route information from said picture information management server;
searches said advertisement information database by using as a search key said photographing coordinated information of said picture information, said location coordinate information and said business time information, to extract advertisement information effective when said mobile terminal arrives at a location corresponding to a location corresponding to the photographing coordinate information of said picture information;
generates an advertisement window mapping said picture information and said advertisement information extracted in correspondence with said picture information along a route on a map; and
transmits said advertisement window to said mobile terminal, and
wherein said advertisement window having said picture information, a name of said extracted advertisement information, and access information to a location of said extracted advertisement information.

2. The advertisement information providing server according to claim 1, wherein:
said picture information management server stores said picture information posted by a post member and having a search keyword;
said advertisement information has type information to be used as said search keyword; and
when said route information is to be received, the advertisement information providing server receives said search keyword, and generates said advertisement window having said picture information corresponding to said keyword and said advertisement information.

3. A mobile terminal in an advertisement information providing system, comprising:
a position confirming unit;
map information; and
a display apparatus,
said mobile terminal connecting an advertisement information providing server via a communication unit to acquire information on a route to a destination and advertisement information regarding said route, wherein:
the mobile terminal displays a destination selection screen on said display apparatus, receives destination information and departure time information, transmits said destination information and said departure time to said advertisement information providing server;
acquires an advertisement window to be mapped along a route corresponding to said destination information, from said advertisement information providing server; and
maps said advertisement window on a map having said route corresponding to said information on said route, and displays said advertisement window and said map on said display apparatus, and
wherein said advertisement window having picture information with photographing coordinate information corresponding to said information on said route, coordinate information on a location near to a location corresponding to said photographing coordinate information, advertisement information effective when the mobile terminal arrives at a location corresponding to said photographing coordinate information, and access information to said coordinate information of said advertisement information.

4. The mobile terminal according to claim 3, wherein the mobile terminal calculates again said access information in accordance with a predetermined running distance acquired by said position confirming unit to renew said access information when necessary.

5. The mobile terminal according to claim 3, wherein:
the mobile terminal displays, when said advertisement window is acquired from said advertisement information providing server, a whole route display screen on said display apparatus, said whole route display screen displaying said route to the destination to obtain user confirmation;
receives the user confirmation of said route on said whole route display screen, and displays a present position guide screen on said display apparatus, said present position guide screen having said route having as a center a present position of the mobile terminal;
said whole route display screen has a whole route display area for displaying a map mapping said advertisement window along said route and a window display area for displaying an enlarged window enlarging said advertisement window;
said present position guide screen displays a map mapping said advertisement window along said route; and
said advertisement window on said present position guide screen is displayed in an enlarged size at a position outside said route, when the mobile terminal arrives near at a location corresponding to a predetermined distance.

6. The mobile terminal according to claim 4, wherein:
the mobile terminal displays, when said advertisement window is acquired from said advertisement information providing server, a whole route display screen on said display apparatus, said whole route display screen displaying said route to the destination to obtain user confirmation;
receives the user confirmation of said route on said whole route display screen, and displays a present position guide screen on said display apparatus, said present position guide screen having said route having as a center a present position of the mobile terminal;
said whole route display screen has a whole route display area for displaying a map mapping said advertisement window along said route and a window display area for displaying an enlarged window enlarging said advertisement window;
said present position guide screen displays a map mapping said advertisement window along said route; and
said advertisement window on said present position guide screen is displayed in an enlarged size at a position outside said route, when the mobile terminal arrives near at a location corresponding to a predetermined distance.

7. The advertisement information providing server according to claim 1, further comprising a member management database storing profile information of each user of said mobile terminal, wherein said advertisement information management database stores profile information of each advertiser, and when said advertisement information is to be extracted, said profile information is used as one of search conditions.

8. The advertisement information providing server according to claim 1, wherein said advertisement information management database stores advertisement display area information set by an advertiser, and when said advertisement information is to be extracted, said advertisement display area information is used as one of search conditions.

9. The advertisement information providing server according to claim 1, wherein said mobile terminal acquires information on a position and a date/time where and when said mobile terminal stops for a predetermined time, from said mobile terminal;
judges whether said stop position coincides with said location coordinate information in said advertisement information management database; and
if coincides, records said date/time information and a user number of said mobile terminal.
